(19) United States
(12) Patent Application Publication
(10) Pub. No.: US 2010/0154366 A1
(43) Pub. Date: Jun. 24, 2010

(54) Leg sock for horses

(76) Inventor: Raymond Petterson, Havana, FL (US)

Correspondence Address: John Wiley Horton;Pennington, Moore, Wilkinson, Bell & Dunbar, P.A., 215 S. Monroe St, 2nd Floor, Tallahassee, FL, 32301, US

(21) Appl. No.: 12/317,655

(22) Filed: Dec. 24, 2008

(51) Int. Cl. B68C 5/00

(52) U.S. Cl. 54/82

(57) ABSTRACT

The present invention comprises a sock for use on the leg of a horse or ungulate, such as a cow, donkey or other hoofed animal. In the preferred embodiment the sock is tubular in shape having an upper opening and a lower opening. The sock is generally comprised of an upper cuff, main body and lower cuff. The upper cuff is configured to frictionally engage the leg of the horse such that the sock will not easily slip down on the leg of the horse. The main body is hollow and is configured to bunch together to hold the horse's body heat close to the leg of the horse. The lower cuff is configured to expand over said hoof of said ungulate and when over the hoof conform to or hug the small pastern.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of horse leggings. More specifically, the invention comprises a sock that fits over the leg of a horse for protection or heating purposes.

2. Description of the Related Art

Horses spend a great deal of time outside in both the winter and the summer months. Due to exposure of the legs of a horse to inclement weather, insects, and plants, a horse would benefit a great deal from a leg sock. Additionally, horses suffer from a number of different medical conditions related to their legs. A properly designed leg sock can offer some relief for leg conditions such as arthritis by keeping the legs insulated from cold temperatures. The act of insulating the leg can also benefit the horse by keeping its leg warm prior to racing, jumping, or other activities, thus reducing the risk of common leg injuries.

Previously, leg socks, braces, or wraps contained loops, snaps, zippers, straps, or other means of securing the device in place on the horse's leg. However, these attachment means can cause problems for the horse, such as if the horse gets caught in a pasture hazard because of the attachment device or if the horse handler puts the device on incorrectly. This can be detrimental to the horse's health.

Therefore it is desirable to create a sock that is easy to take on and off and will remain secure on the horse's leg by frictional engagement and light elastic compression while the horse moves around. The present invention achieves this objective, as well as others that are explained in the following description.

### BRIEF SUMMARY OF THE INVENTION

The present invention comprises a sock for use on the leg of a horse or other hoofed ungulates, such as a cow or a donkey. In the preferred embodiment the sock is tubular in shape having an upper opening and a lower opening. The sock is generally comprised of an upper cuff, main body, and lower cuff. The upper cuff is configured to frictionally engage the leg of the horse such that the sock will not easily slip down on the leg of the horse. The main body is hollow and is configured to bunch together to hold the horse's body heat close to the leg of the horse. The lower cuff is configured to expand in order to pass over the hoof of the ungulate and once clear of the hoof, then conform to the smaller shape of the pastern, preventing the sock from slipping back down over the hoof.

In the alternate embodiment the upper cuff, the main body and the lower cuff are fully integrated to form an integrated portion. The integrated portion is configured to engage the leg of the horse without constricting circulation in the body of the leg.

### BRIEF DESCRIPTION OF THE SEVERAL VIEWS OF THE DRAWINGS

FIG. 1 is a perspective view, showing the present invention.

FIG. 2 is a perspective view, showing the present invention on the leg of a horse.

FIG. 3 is a perspective view, showing the present invention over a hoof of a horse.

FIG. 4 is a perspective view, showing the present invention being put on a horse.

FIG. 5 is a perspective view, showing a user taking the present invention off of a horse.

FIG. 6 is a perspective view, showing the bottom cuff of the present invention.

FIG. 7 is a perspective view, showing the present invention.

FIG. 8 is a perspective view, showing an alternate embodiment of the present invention.

FIG. 9 is a perspective view, showing the bottom cuff of an alternate embodiment of the present invention.

FIG. 10 is a perspective view, showing an alternate embodiment of the present invention.

### REFERENCE NUMERALS IN THE DRAWINGS

| | | | |
|---|---|---|---|
| 10 | sock | 12 | sock |
| 14 | upper cuff | 16 | main body |
| 18 | lower cuff | 20 | horse |
| 22 | foreleg | 24 | hind leg |
| 26 | hoof | 28 | handler |
| 30 | integrated portion | 32 | lower cuff |
| 34 | knee | 36 | toe |
| 38 | walls | 40 | heel |
| 42 | pastern | 44 | coronet band |
| 46 | upper opening | 48 | lower opening |
| 50 | fetlock | 52 | hock |

### DETAILED DESCRIPTION OF THE INVENTION

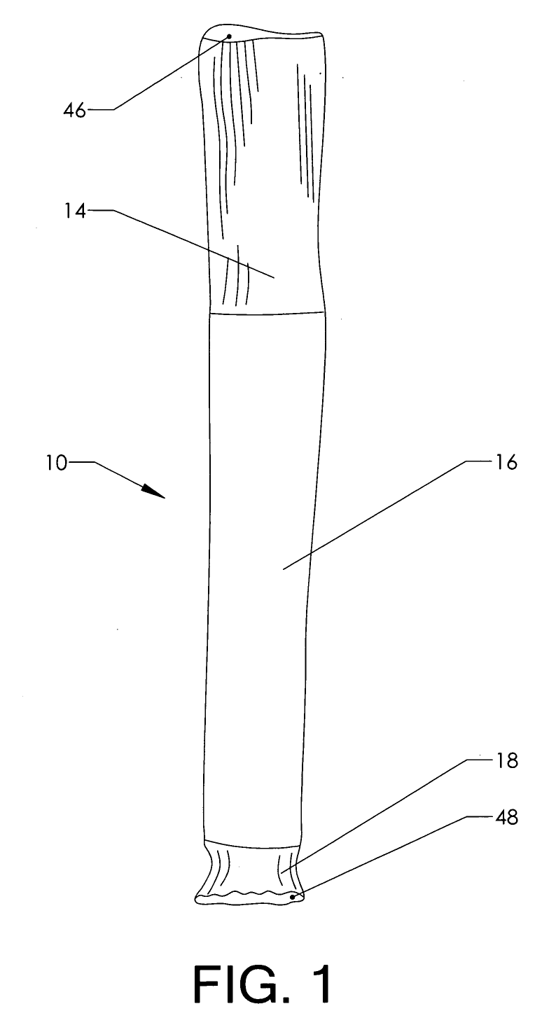

FIG. 1 illustrates the present sock 10. The sock 10 is generally comprised of upper cuff 14, main body 16, and lower cuff 18. The sock 10 is tubular in shape having a hollow center containing upper opening 46 at the top of sock 10 and lower opening 48 at the bottom of sock 10. Lower cuff 18 is located at the bottom of main body 16 and is bell-shaped. Lower cuff 18 is compactly cross stretch knitted allowing lower cuff 18 to easily expand and contract. The present embodiment of the present sock 10 has upper cuff 18 located at the top of sock 10. In its relaxed state upper cuff 18 has a smaller diameter than the diameter of main body 16 in its relaxed state.

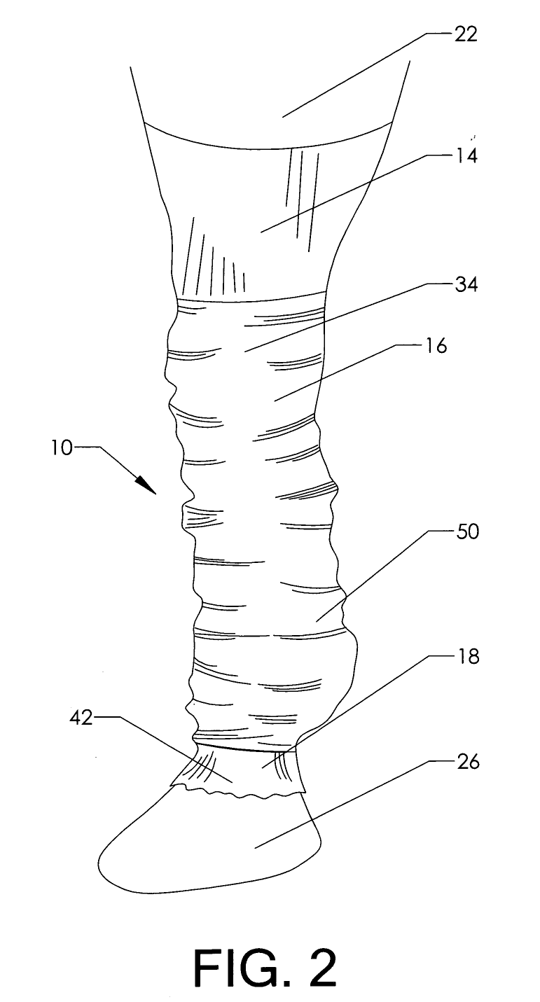

The present sock 10 is shown on a horse leg 22 in FIG. 2. Upper cuff 14 sits above knee 34 on foreleg 22. Main body 16 has the ability to bunch together, thereby insulating and warming foreleg 22. Main body 16 covers fetlock 50. Lower cuff 18 expands over hoof 26 and fits comfortably on pastern 42 above hoof 26.

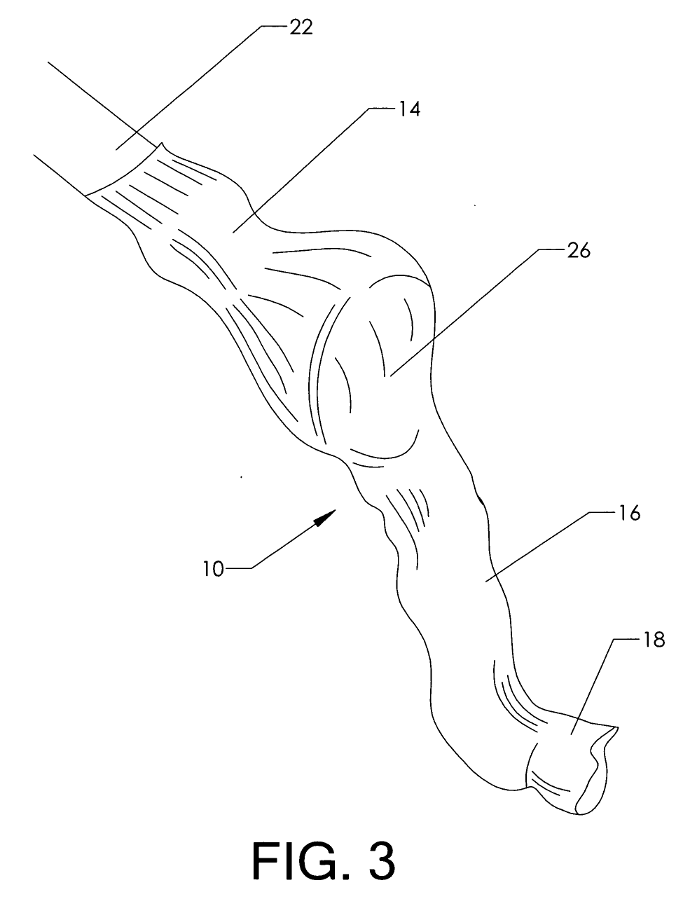

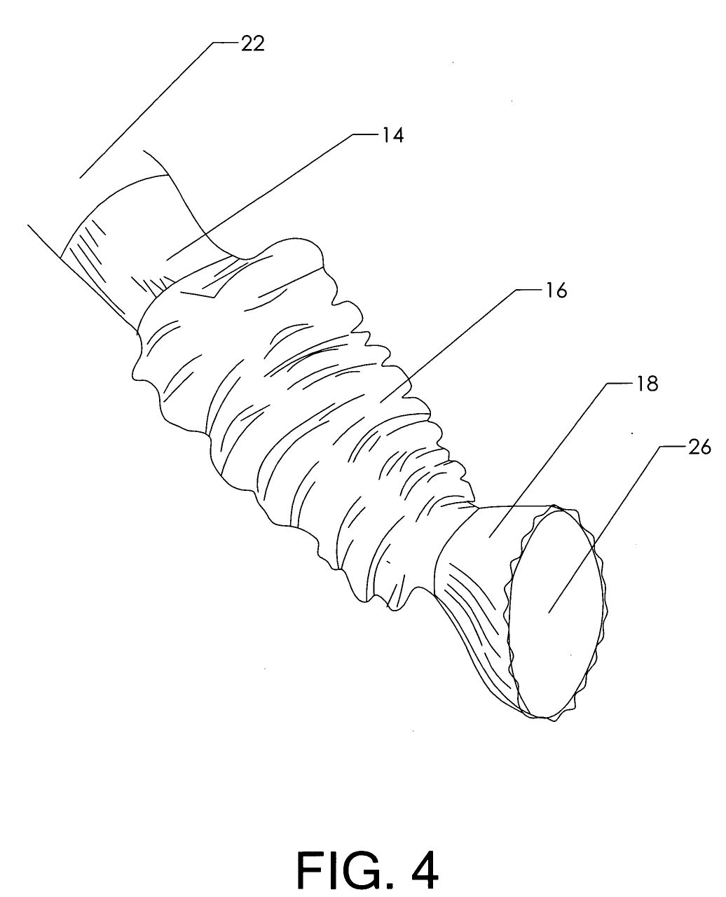

In FIG. 3 the reader can see how the present sock 10 is placed onto foreleg 22. The horse's handler gently lifts foreleg 22 off of the ground and slips upper cuff 14 followed by main body 16 over the horse's hoof 26. Lower cuff 18 stretches over hoof 26. However, once it passes over the hoof lower cuff 18 contracts again to tightly fit pastern 42, as shown in FIG. 4.

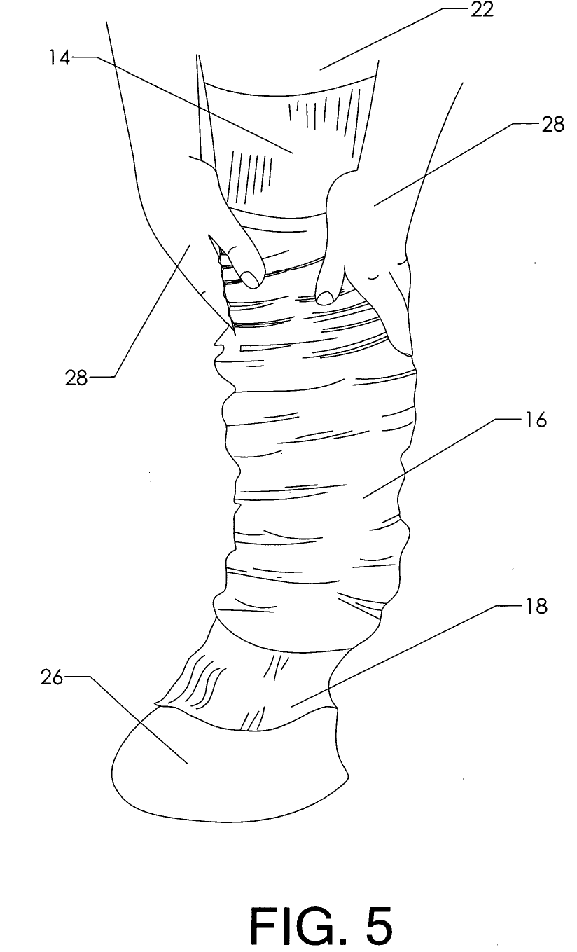

As shown in FIG. 5 handler 28 can easily adjust the present sock 10 on the horse's leg 22 so that main body 16 bunches together. The absence of an attachment means, such as Velcro, snaps, loops, or ties, eliminates the risk of handler 28 applying the present sock 10 in a manner that could injure the horse by wrapping or applying the attachment means in a way that causes improper vascular constriction or tendon constriction. Additionally, the absence of an attachment means reduces the risk of the sock becoming tangled in a potential pasture hazard, such as a fence post, thereby causing damage to the horse's leg. The present sock 10 is designed to slip off leg 22 easily if the sock 10 gets caught up in any significant external hazard.

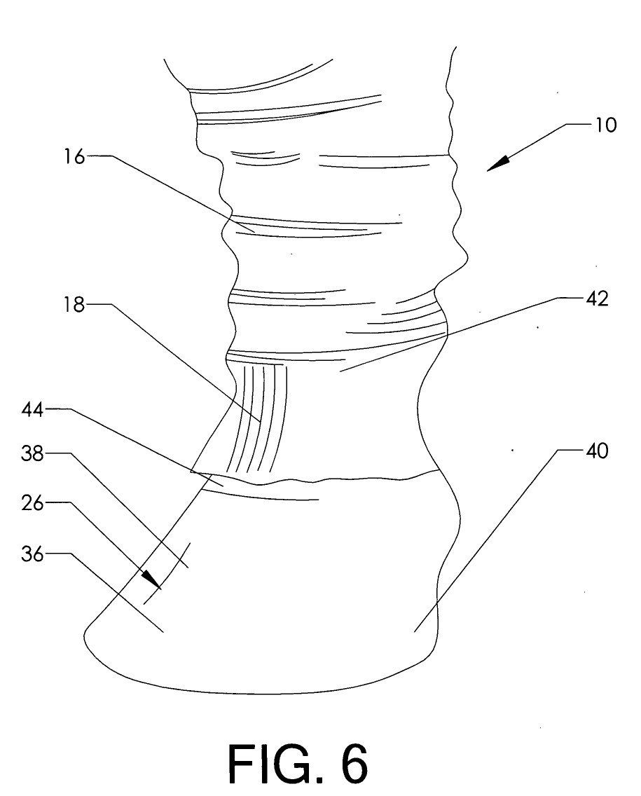

FIG. 6 illustrates lower cuff 18 and its location on the horse's hoof 26. Main body 16 bunches just above lower cuff 18. As illustrated, a horse's hoof 26 contains toe 36, heel 40, pastern 42 (covered by present sock 10), coronet band 44, and walls 38. Lower cuff 18 covers pastern 42 and ends just above coronet band 44. Lower cuff 18 acts to prevent main body 16 from slipping over walls 38, toe 36, and heel 40.

Returning to FIG. 2 upper cuff 14 is located above the knee 34. Since upper cuff 14 would have to expand to pass over the knee 34, upper cuff 14 tends to hold the sock up. Lower cuff 18 is located in the reduced diameter of the pastern 42. Lower cuff 18 would have to expand to move up onto the fetlock 50 or down onto the hoof 26. Thus the two elastic cuffs hold the sock in place.

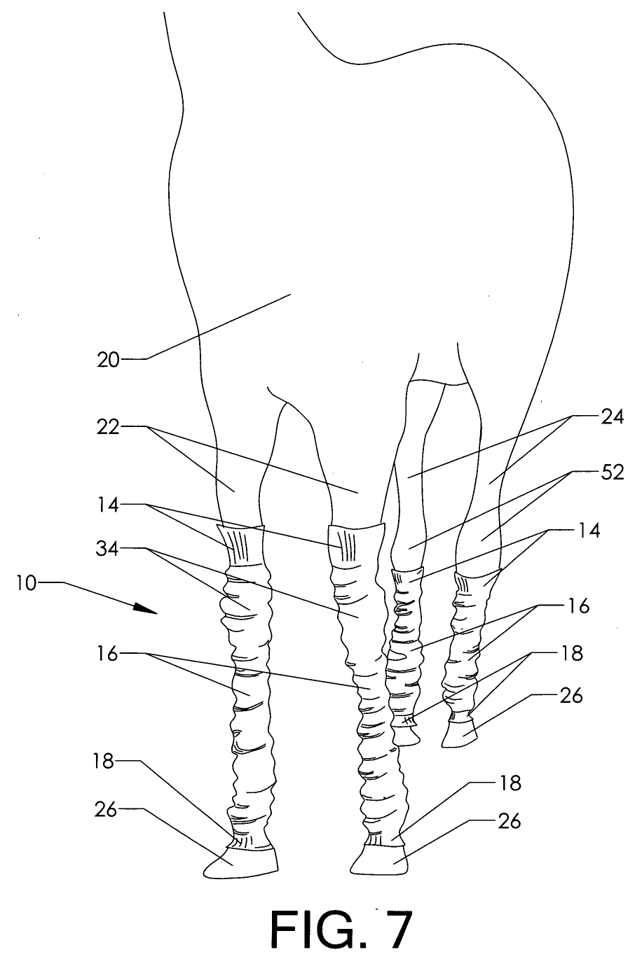

The present sock 10 is shown in FIG. 7 on both forelegs 22 and hind legs 24 of the horse 20. On forelegs 22, upper cuffs 14 of socks 10 are pulled above the horse's knee 34. However, on the horse's hind legs 24, upper cuffs 14 sit just below the horse's hocks 52 so as to allow the hind legs 24 full range of motion. As shown, a large proportion of the horse's four legs are covered by the present socks 10. This benefits the horse by keeping the legs warm in the winter or before or after strenuous activity and by protecting the legs from insects and minor scratches from branches or brush.

The present sock 10 is preferably knitted from a yarn that has the ability to insulate the horse's leg, and frictionally engage the horse's leg while avoiding constriction of the leg or compromising circulation in any manner. One example of a yarn containing these properties would be a yarn containing cotton, polyester, nylon, elastand (spandex) and/or elastic hydrocarbon polymer (rubber). The fibers are preferably treated with FOSSHIELD® fiber technology (as discussed below). Main body 16 of the present sock 10 can be knitted using a thick cable knit stitch, in which the order of the stitches is permuted, to utilize as much yarn as possible, thereby adding insulation value to the present sock 10. Ordinarily cable knitting increases the density and reduces the elasticity of the fabric. However, by plaiting elastand (spandex) and elastic hydrocarbon polymer (rubber) into the yarn, the present sock 20 can still expand easily while also retaining the density of the weave. Additionally, the elastic hydrocarbon polymer (rubber) increases the ability of the fabric to frictionally engage with the horse's leg.

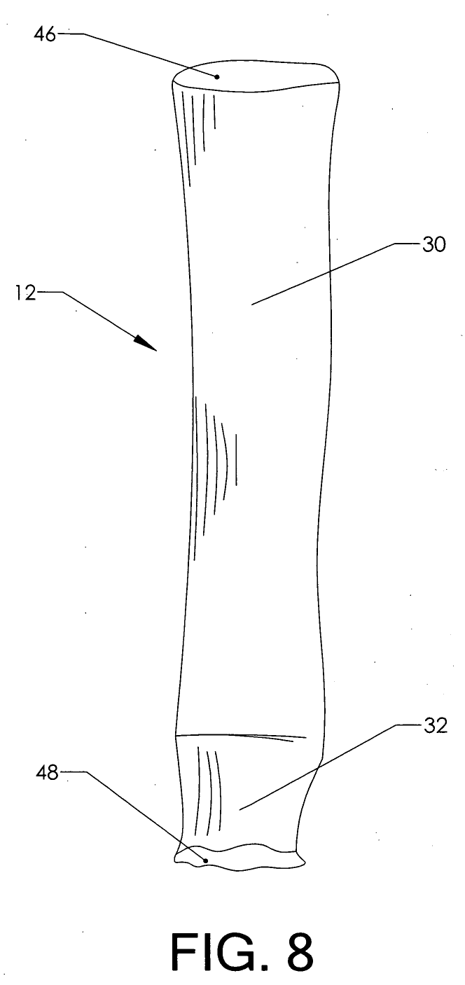

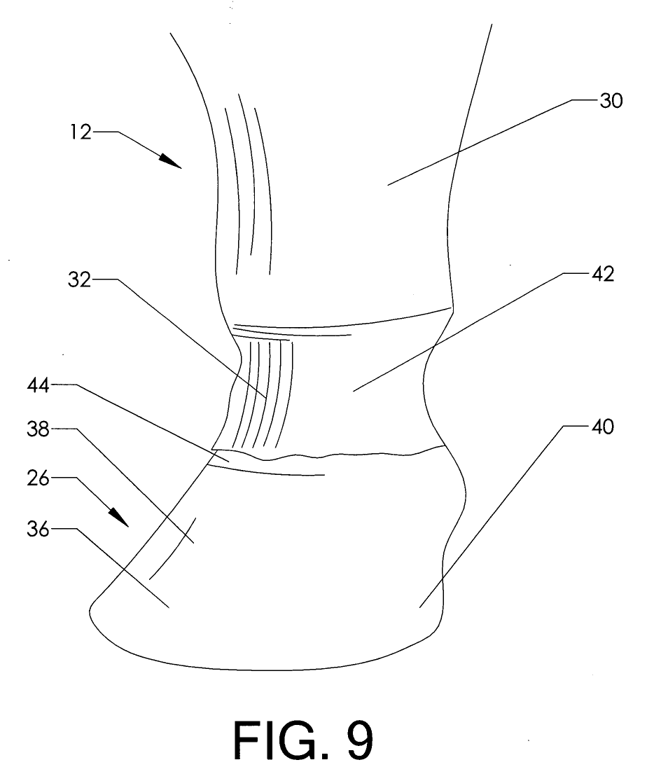

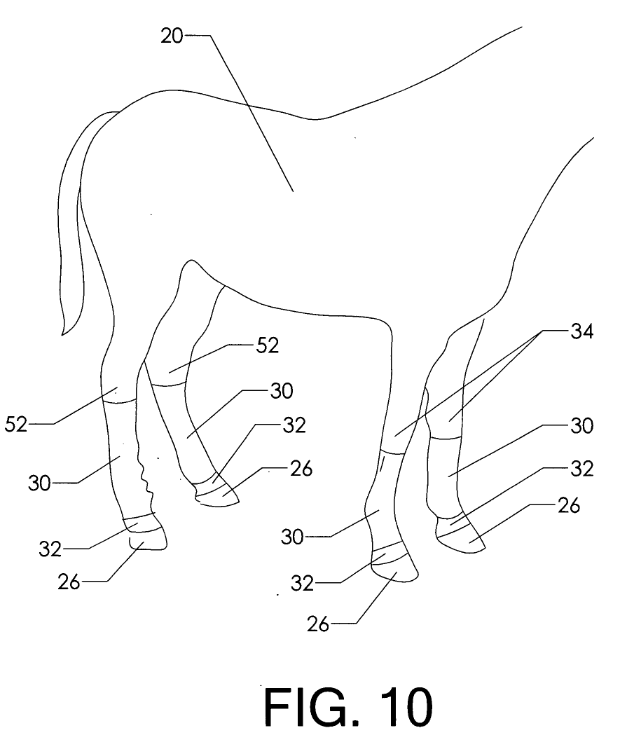

An alternate embodiment of the present invention is shown in FIG. 8. In the alternate embodiment, main body 16 and upper cuff 14 (illustrated in FIG. 1) are fully integrated and are shown as integrated portion 30 in FIG. 8, thereby eliminating the appearance of upper cuff 14. Lower cuff 32 is still present as described in the preferred embodiment. Integrated portion 30 is knitted such that integrated portion 30 does not readily expand or bunch together. As shown in FIG. 9, lower cuff 32 still expands easily and fits comfortably over small pastern 42 without causing unnecessary constriction. Again, lower cuff 32 comes to a rest just above coronet band 44. FIG. 10 illustrates the placement of socks 12 just below knees 34 and hocks 52 of horse 20. Socks 12 are held in place by frictional engagement. It is important that no straps, buttons, snaps, loops or Velcro are used to attach or constrict the socks 12 to the horse's legs.

Additionally, the alternate embodiment can be knitted from various materials. However, one good approach is to use a yarn treated with a FOSSHIELD® fiber treatment in which the fibrous material, or yarn in the present embodiment, is embedded with silver and copper ions. Foss Manufacturing Company, LLC, of Hampton, N.H. developed FOSSHIELD® fabric technology which safely and naturally inhibits the growth of destructive and odor-causing bacteria, fungi, and mold, in the socks. The use of FOSSHIELD® fabric technology allows for a clean environment around the leg of the horse.

The alternate embodiment, present sock 12, is preferably knitted from a yarn that has the ability to wick moisture and heat away from the horse's leg thereby keeping the leg cool. An example of a yarn containing these properties would be a yarn comprised of a blend of polyester, elastand (spandex), elastic hydrocarbon polymer (rubber) and treated with FOSSHIELD® fiber technology (as discussed above).

The preceding description contains significant detail regarding the novel aspects of the present invention. It should not be construed, however, as limiting the scope of the invention but rather as providing illustrations of the preferred embodiments of the invention. As an example, upper cuff 14 and main body 16 can be knitted in the same manner thereby effectively eliminating the appearance of an upper cuff 14. Thus, the scope of the invention should be fixed by the following claims, rather than by the examples given.

1. A method for applying a sock, having a tubular shape, to a leg of an ungulate, wherein said ungulate has a hoof and a pastern on said leg, wherein said leg and said pastern have a diameter, comprising the steps of:
a. providing a sock to said leg of said ungulate, said sock including:
i. an upper cuff having a lower end and an upper end:
(a) wherein said upper cuff further comprises an upper opening;
(b) wherein said upper cuff is configured to expand sufficiently to fit over said hoof;
ii. a main body having a lower end and an upper end:
(a) wherein said upper end of said main body is located below said lower end of said upper cuff,
(b) wherein said main body is hollow; and
(c) wherein said main body is configured to expand sufficiently to fit over said hoof;
iii. a lower cuff having an upper end and a lower end:
(a) wherein said upper end of said lower cuff is located below said lower end of said main body;
(b) wherein said lower cuff is configured to expand over said hoof; and
(c) wherein said lower end of said lower cuff has a lower opening;
b. placing said sock over said hoof of said ungulate;
c. adjusting said sock such that said upper cuff frictionally engages said leg of said ungulate; and
d. adjusting said sock such that said lower cuff conforms to said pastern of said ungulate.

2. The method as recited in claim 1, further comprising the steps of providing a sock comprised of a plurality of strands of yarn.

3. The method as recited in claim 2, further comprising the steps of providing a sock wherein said plurality of strands of yarn are comprised of:
a. cotton;
b. polyester;
c. nylon;
d. elastand; and
e. elastic hydrocarbon polymer.

4. The method as recited in claim 3, further comprising the steps of providing a sock wherein said plurality of strands of yarn are treated with FOSSHIELD® technology.

5. The method as recited in claim 1, further comprising the steps of providing a sock wherein said lower cuff is configured to loosely hug said pastern of said hoof.

6. The method as recited in claim 2, further comprising the steps of providing a sock wherein said plurality of strands of yarn are knitted together utilizing a cable knit stitch on said main body of said sock.

7. The method as recited in claim 2, further comprising the steps of providing a sock wherein said main body is configured to bunch together over said leg of said ungulate.

8. The method as recited in claim 1, further comprising the steps of providing a sock wherein said upper cuff and said lower cuff have a diameter in a relaxed state, wherein said diameter of said upper cuff in said relaxed state is smaller than said diameter of said leg of said ungulate and wherein said diameter of said lower cuff in said relaxed state is smaller than said diameter of said pastern.

9. A method for applying a sock, having a tubular shape, to a leg of an ungulate, wherein said ungulate has a hoof on said leg, comprising the steps of:
a. providing a sock to said leg of said ungulate, said sock including:
i. an upper cuff having a lower end and an upper end:
(a) wherein said upper cuff further comprises an upper opening;
(b) wherein said upper cuff is configured to expand sufficiently to fit over said hoof;
ii. a main body having a lower end and an upper end:
(a) wherein said upper cuff and said main body are fully integrated to create an integrated portion; and
(b) wherein said main body is configured to expand sufficiently to fit over said hoof;
iii. wherein said integrated portion is hollow;
iv. a lower cuff having an upper end and a lower end:
(a) wherein said upper end of said lower cuff is located below said lower end of said main body;
(b) wherein said lower cuff is configured to expand over said hoof of said ungulate and once over said hoof, contract again to conform to said pastern of said ungulate; and
(c) wherein said lower end of said lower cuff has a lower opening;
b. placing said sock over said hoof of said ungulate;
c. adjusting said sock such that said integrated portion frictionally engages said leg of said ungulate; and
d. adjusting said sock such that said lower cuff conforms to said pastern of said ungulate.

10. The method as recited in claim 9, further comprising the steps of providing a sock wherein said sock is comprised of a plurality of strands of yarn.

11. The method as recited in claim 10, further comprising the steps of providing a sock wherein said plurality of strands of yarn are comprised of:
a. elastic hydrocarbon polymer;
b. elastane; and
c. polyester fabric.

12. The method as recited in claim 11, further comprising the steps of providing a sock wherein said plurality of strands of yarn further comprise a plurality of FOSSHIELD® fibers.

13. The method as recited in claim 10, further comprising the steps of providing a sock wherein said lower cuff is configured to hug said pastern.

14. The method as recited in claim 10, further comprising the steps of providing a sock wherein said integrated portion is configured to expand to fit said leg of said ungulate without constricting the blood flow to said leg.

15. A method for applying a sock, having a tubular shape, to a leg of an ungulate, wherein said ungulate has a hoof, a knee or a hock, and a pastern on said leg, wherein said leg and said pastern have a diameter, comprising the steps of:
a. providing a sock to said leg of said ungulate, said sock including:
i. an upper cuff having a lower end and an upper end:
(a) wherein said upper cuff further comprises an upper opening;
(b) wherein said upper cuff is configured to frictionally engage said leg of said ungulate; and
(c) wherein said upper cuff is configured to expand sufficiently to fit over said hoof;
ii. a main body having a lower end and an upper end:
(a) wherein said upper end of said main body is located below said lower end of said upper cuff;
(b) wherein said main body is hollow; and
(c) wherein said main body is configured to expand sufficiently to fit over said hoof;
iii. a lower cuff having an upper end and a lower end:
(a) wherein said upper end of said lower cuff is located below said lower end of said main body;
(b) wherein said lower cuff is configured to expand over said hoof and once clear of said hoof, contract again to conform to said pastern of said ungulate; and
(c) wherein said lower end of said lower cuff has a lower opening;
iv. wherein said upper end of said upper cuff is a set distance from said lower end of said lower cuff;
v. wherein said set distance is sufficient to allow said upper end of said upper cuff to reach said knee or said hock and said lower end of said lower cuff to reach said pastern;
vi. wherein said upper cuff is configured to have a smaller diameter than said diameter of said leg in a relaxed state; and
vii. wherein said lower cuff is configured to have a smaller diameter than said diameter of said pastern in a relaxed state;
b. placing said sock over said hoof of said ungulate;
c. adjusting said sock such that said upper cuff frictionally engages said leg of said ungulate; and
d. adjusting said sock such that said lower cuff conforms to said pastern of said ungulate.

16. The method as recited in claim 15, further comprising the steps of providing a sock wherein said sock is comprised of a plurality of strands of yarn.

17. The method as recited in claim 16, further comprising the steps of providing a sock wherein said plurality of strands of yarn are comprised of:
a. elastic hydrocarbon polymer;
b. elastane; and
c. polyester fabric.

18. The method as recited in claim 17, further comprising the steps of providing a sock wherein said plurality of strands of yarn further comprise a plurality of FOSSHIELD® fibers.

19. The method as recited in claim 15, further comprising the steps of providing a sock wherein said lower cuff is configured to hug said pastern.

20. The method as recited in claim 15, further comprising the steps of providing a sock wherein said integrated portion is configured to expand to fit said leg of said ungulate without constricting the blood flow to said leg.
